(19) United States
(12) Patent Application Publication
(10) Pub. No.: US 2026/0017551 A1
(43) Pub. Date: Jan. 15, 2026

(54) INJECTION OF MULTIPLE QUBITS INTO LOGICAL STATES OF A STABILIZER QUANTUM CODE

(71) Applicant: Microsoft Technology Licensing, LLC, Redmond, WA (US)

(72) Inventors: Matthew Benjamin HASTINGS, Seattle, WA (US); Zhenghan WANG, Goleta, CA (US); David Alexander AASEN, Santa Barbara, CA (US); Jeongwan HAAH, Bellevue, WA (US)

(21) Appl. No.: 18/772,369

(22) Filed: Jul. 15, 2024

(51) Int. Cl. G06N 10/40; G06N 10/70

(52) U.S. Cl. CPC G06N 10/40; G06N 10/70

(57) ABSTRACT

Aspects of the disclosure include injecting a magic state in a code. Aspects include preparing the magic state on a first set of physical qubits, initializing a second set of the physical qubits to X=+1 state, and initializing a third set of the physical qubits to Y=+1 state. Aspects include initializing a fourth set of the physical qubits to Z=+1 state and measuring stabilizers of the code, thereby resulting in the magic state being injected into the code.

### INTRODUCTION

The subject disclosure relates to quantum circuits, and particularly to a quantum computer for injection of multiple qubits into logical states of a stabilizer quantum code.

A quantum computer is a physical machine configured to execute logical operations based on or influenced by quantum-mechanical phenomena. Such logical operations may include, for example, mathematical computation. Current interest in quantum-computer technology is motivated by analysis suggesting that the computational efficiency of an appropriately configured quantum computer may surpass that of any practicable non-quantum computer when applied to certain types of problems. Such problems include computer modeling of natural and synthetic quantum systems, predicting the behavior of new molecules and materials, integer factorization, and machine learning. Furthermore, it has been predicted that continued miniaturization of conventional computer logic structures will ultimately lead to the development of nanoscale logic components that exhibit quantum effects and should therefore be addressed according to quantum-computing principles.

Different types of quantum computers base their operation on different quantum-mechanical phenomena. A “topological” quantum computer is a quantum computer whose operation is based on a non-Abelian topological phase of matter that may support “braidable” quasiparticles. This type of quantum computer is expected to be less prone to the issue of quantum decoherence than other types of quantum computers, and may therefore serve as an efficient platform to implement fault-tolerant quantum computing.

### SUMMARY

Embodiments of the present invention are directed to methods for injection of multiple qubits into logical states of a stabilizer quantum code. A non-limiting example method includes preparing the magic state on a first set of physical qubits, initializing a second set of the physical qubits to X=+1 state, and initializing a third set of the physical qubits to Y=+1 state. The method includes initializing a fourth set of the physical qubits to Z=+1 state and measuring stabilizers of the code, thereby resulting in the magic state being injected into the code.

The above features and advantages, and other features and advantages of the disclosure are readily apparent from the following detailed description when taken in connection with the accompanying drawings. This Summary is provided to introduce in simplified form a selection of concepts that are further described in the Detailed Description. This Summary is not intended to identify key features or essential features of the claimed subject matter, nor is it intended to be used to limit the scope of the claimed subject matter. The claimed subject matter is not limited to implementations that solve any or all disadvantages noted in any part of this disclosure.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts an example quantum computer configured to execute quantum-logic operations in accordance with one or more embodiments;

FIG. 2 depicts an illustration of a Bloch sphere that provides a graphical description of some quantum mechanical aspects of an individual qubit in accordance with one or more embodiments;

FIG. 3 is a graph of example signal levels and associated durations to assert a quantum-gate operation on one or more qubits of a quantum circuit in accordance with one or more embodiments;

FIG. 4 depicts a layout of a quantum circuit in accordance with one or more embodiments;

FIG. 5 depicts a block diagram of a classical computer system according to one or more embodiments;

FIG. 6 depicts a schematic of a protocol for encoding a magic state in a quantum error correction code in accordance with one or more embodiments;

FIG. 7 depicts first stabilizer measurements, second stabilizer measurements, and third stabilizer measurements for X stabilizers and Z stabilizers in accordance with one or more embodiments;

FIG. 8 depicts a schematic of a protocol for encoding a magic state in a quantum error correction code in accordance with one or more embodiments;

FIG. 9 depicts first stabilizer measurements, second stabilizer measurements, and third stabilizer measurements for X stabilizers and Z stabilizers in accordance with one or more embodiments;

FIG. 10 depicts a flowchart of computer-implemented method for injecting a magic state into logic states of a stabilizer quantum code in accordance with one or more embodiments; and

FIG. 11 depicts a flowchart of computer-implemented method for injecting a magic state into logic states of a stabilizer quantum code in accordance with one or more embodiments.

The diagrams depicted herein are illustrative. There can be many variations to the diagram or the operations described therein without departing from the spirit of the invention. For instance, the actions can be performed in a differing order or actions can be added, deleted or modified.

In the accompanying figures and following detailed description of the described embodiments of the invention, the various elements illustrated in the figures are provided with two or three-digit reference numbers. With minor exceptions, the leftmost digit(s) of each reference number corresponds to the figure in which its element is first illustrated.

### DETAILED DESCRIPTION

In accordance with one or more embodiments, a system, a method, a classical computer coupled to a quantum computer, and/or a quantum computer are configured and arranged to provide the injection of multiple qubits into logical states of a stabilizer quantum code executed on quantum circuits of a quantum computer.

A quantum error correcting code is defined by an isometric linear map from a Hilbert space of k qubits, called logical qubits, to a larger Hilbert space of n qubits, called the physical qubits of the code, for some integers k and n with n>k. A stabilizer quantum error correcting code is an error correcting code where the image of this map is the joint eigenspace of n-k independent, mutually commuting operators, termed stabilizers, each of which is a product of Pauli operators on one or more physical qubits. A CSS stabilizer quantum error correcting code is a stabilizer quantum error correcting code where each stabilizer is a product of either Pauli X operators on some qubits, or Pauli Z operators, but not both. A non-CSS stabilizer quantum error correcting code is a stabilizer quantum error correcting code in which one or more of the stabilizers cannot be expressed as a product of only Pauli X or only Pauli Z operators. Injecting some state into a quantum error correcting code means preparing a state of physical qubits which is the image of this state under the given isometric linear map.

Quantum gates represent the operations that can be performed on qubits. A universal gate set is a set of these quantum gates that enable universal quantum computation, which means that all possible operations are enabled. The gates include in this set include both Clifford gates and non-Clifford gates.

Clifford gates can be efficiently simulated with classical computers, and they are transversal, which means they can be efficiently applied to logical qubits. They can be applied by quantum error correction codes, which means they are useful for fault-tolerant quantum computing (FTQC). Non-Clifford gates cannot be efficiently simulated with classical computers, nor can they be efficiently applied to logical qubits. To achieve universal FTQC, it would help to have some way to efficiently implement non-Clifford logical gates.

Magic state quantum computing is a possible solution. Magic states require preparation in advance, after which they are ready to be utilized. Because non-Clifford gates are inefficient to implement, their effects are encoded into quantum states in advance. At the appropriate times during computation, these pre-prepared “magic states” are used, leaving the rest of the computation to the Clifford gates, which can be implemented efficiently.

A magic state, simply put, is a quantum state that is prepared in advance because it otherwise cannot be implemented efficiently. Magic state injection is the incorporation of this pre-prepared state into fault-tolerant quantum computation. However, this process can be noisy and may not be implemented perfectly. The solution for this is magic state distillation. Analogous to how distillation is used to separate the components of liquids to achieve higher concentrations of certain components, magic state distillation takes many noisy quantum states and returns more accurate quantum states, possibly fewer in number. The resultant magic state-based effects, in conjunction with Clifford gates, implement the desired non-Clifford operations.

Quantum computing can utilize methods that suppress errors in faulty qubits. Quantum error correction is a broad class of techniques that encode “logical” qubits and gates in a subspace of the Hilbert space formed by many more “physical” qubits and gates. The structure of a quantum code has an influence on how logical gates are enacted on the physical qubits, and hence the total size and execution time of a quantum computation.

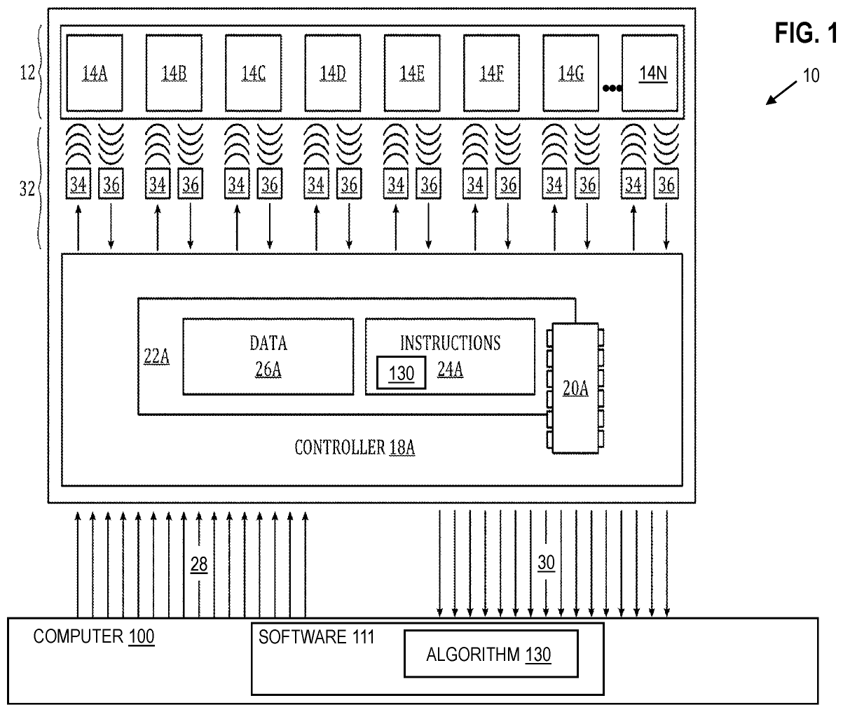

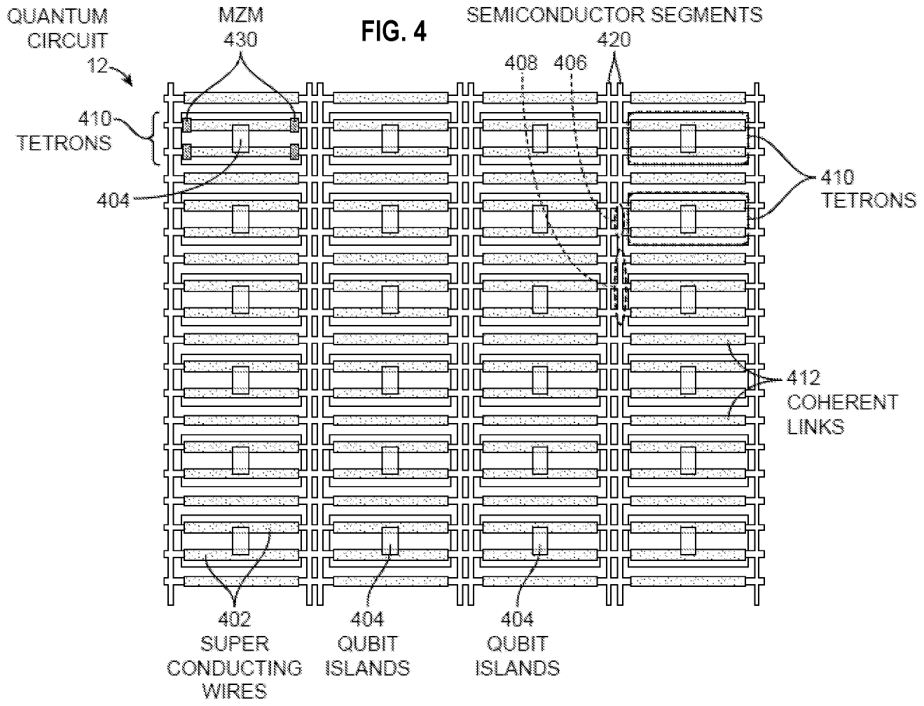

Example Quantum Computer Architecture: FIG. 1 illustrates an example quantum computer 10 configured to execute quantum-logic operations. While conventional computer memory holds digital data in an array of bits and enacts bit-wise logic operations, a quantum computer holds data in an array of qubits and operates quantum-mechanically on the qubits in order to implement the desired logic. Accordingly, quantum computer 10 of FIG. 1 includes at least one quantum circuit 12 having an array of physical qubits 14A, 14B, and 14C-14N, where N is the last number of qubits. The qubits 14A-14N can be referred to collectively as qubits 14. The quantum circuit 12 of the array of qubits 14 can be arranged in a lattice structure as depicted in FIG. 4.

The qubits 14 of the quantum circuit 12 take various forms, depending on the desired architecture of the quantum computer 10. While this disclosure relates to qubits embodied as quasiparticles in a non-Abelian topological phase, a qubit alternatively can include: a superconducting Josephson junction, a trapped ion, a trapped atom coupled to a high-finesse cavity, an atom or molecule confined within a fullerene, an ion or neutral dopant atom confined within a host lattice, a quantum dot exhibiting discrete spatial- or spin-electronic states, electron holes in semiconductor junctions entrained via an electrostatic trap, a coupled quantum-wire pair, an atomic nucleus addressable by magnetic resonance, a free electron in helium, a molecular magnet, or a metal-like carbon nanosphere, as non-limiting examples. More generally, each qubit 14 can include any particle or system of particles that can exist in two or more discrete quantum states that can be measured and manipulated experimentally. For instance, a qubit may be implemented in the plural processing states corresponding to different modes of light propagation through linear optical elements (e.g., mirrors, beam splitters and phase shifters), as well as in states accumulated within a Bose-Einstein condensate.

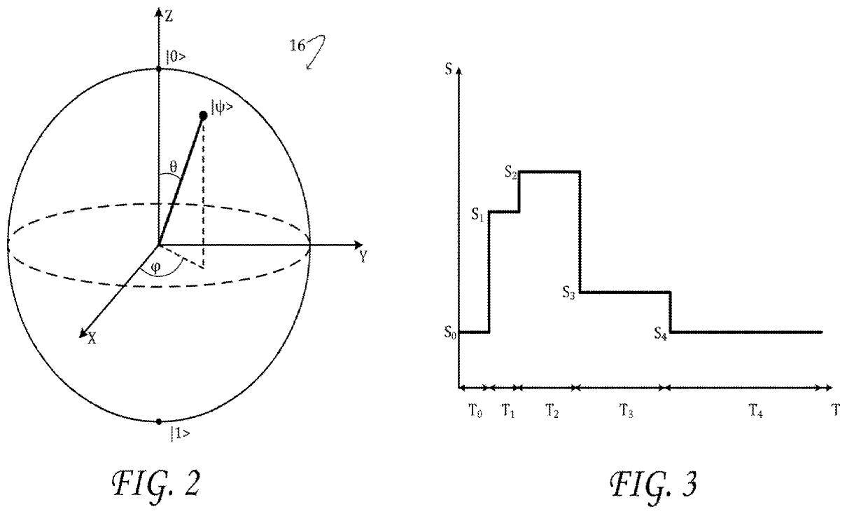

FIG. 2 is an illustration of a Bloch sphere 16 that provides a graphical description of some quantum mechanical aspects of an individual qubit 14. In this description, the north and south poles of the Bloch sphere correspond to the standard basis vectors |0> and |1>, respectively. The set of points on the surface of the Bloch sphere comprise all possible pure states |ψ> of the qubit, while the interior points correspond to all possible mixed states. A mixed state of a given qubit may result from decoherence, which may occur because of undesirable coupling to external degrees of freedom.

Referring to FIG. 1, quantum computer 10 includes a controller 18A. The controller 18A includes at least one processor 20A and associated computer memory 22A. The processor 20A of the controller 18A can be coupled operatively to peripheral componentry, such as network componentry, to enable the quantum computer to be operated remotely. The processor 20A of the controller 18A can take the form of a central processing unit (CPU), a graphics processing unit (GPU), or the like. As such, the controller can include classical electronic componentry. The terms ‘classical’ and ‘non-quantum’ are applied herein to any component that can be modeled accurately as an ensemble of particles without considering the quantum state of any individual particle. Classical electronic components include integrated, microlithographed transistors, resistors, and capacitors, for example. The computer memory 22A can be configured to hold program instructions 24A that cause the processor 20A to execute any function or process of the controller. The computer memory can also be configured to hold additional data 26A. In examples in which quantum circuit 12 is a low-temperature or cryogenic device, the controller 18A can include control componentry operable at low or cryogenic temperatures, for example, a field-programmable gate array (FPGA) operated at 77 kelvin (K). In such examples, the low-temperature control componentry can be coupled operatively to interface componentry operable at normal temperatures.

The controller 18A of the quantum computer 10 is configured to receive a plurality of inputs 28 and to provide a plurality of outputs 30. The inputs and outputs can each include digital and/or analog lines. At least some of the inputs and outputs can be data lines through which data is provided to and/or extracted from the quantum computer. Other inputs can include control lines via which the operation of the quantum computer can be adjusted or otherwise controlled. In one or more embodiments, the quantum computer 10 can be coupled a classical computer 100. Further, details of the example classical computer 100 are discussed in FIG. 27.

The controller 18A is operatively coupled to the quantum circuit 12 via quantum interface 32. The quantum interface 32 is configured to exchange data bidirectionally with the controller 18A. The quantum interface 32 is further configured to exchange signal corresponding to the data bidirectionally with the qubit register. Depending on the architecture of quantum computer 10, such signal may include electrical, magnetic, and/or optical signal. By the signal conveyed through the quantum interface 32, the controller 18A can interrogate and otherwise influence the quantum state held in various qubits 14. For example, the controller 18A can interrogate and otherwise influence the quantum state held a qubit register, as defined by a collective quantum state of a group of qubits 14. The quantum interface 32 includes at least one modulator 34 and at least one demodulator 36, each coupled operatively to one or more qubits 14 of the quantum circuit 12. In one or more embodiments, a modulator 34 and a demodulator 36 can each be coupled to qubits in a qubit register. Each modulator 34 is configured to output a signal to one or more qubits 14 in the quantum circuit 12 based on modulation data received from the controller 18A. In one or more embodiments, at least one modulator 34 can output a signal to qubits in a qubit register based on modulation data received from the controller 18A. Each demodulator 36 is configured to sense a signal from the one or more qubits 14 of the quantum circuit 12 and to output data to the controller 18A based on the signal. In one or more embodiments, each demodulator 36 is configured to sense a signal from the qubit register and to output data to the controller 18A based on the signal. The data received from the demodulator 36 can, in some examples, be an estimate of an observable to the measurement of the quantum state held in one or more qubits 14 in the quantum circuit 12. In one or more embodiments, the data received from the demodulator 36 can be an estimate of an observable to the measurement of the quantum state held in the qubit register.

In some examples, the modulator 34 can transmit a suitably configured signal to interact physically with one or more qubits 14 of the quantum circuit 12 in order to trigger measurement of the quantum state held in one or more qubits 14. The demodulator 36 can then sense a resulting signal released by the one or more qubits 14 pursuant to the measurement and can provide the data corresponding to the resulting signal to the controller 18A. Stated another way, the demodulator 26 is configured to output, based on the signal received, an estimate of one or more observables reflecting the quantum state of one or more qubits of the qubit register, and to furnish the estimate to the controller 18A. In one non-limiting example, the modulator 34 can provide, based on data from the controller 18A, an appropriate voltage pulse or pulse train to an electrode of one or more qubits 14, to initiate a measurement. In short order, the demodulator 36 can sense photon emission from the one or more qubits 14 and can assert a corresponding digital voltage level on a quantum-interface line into the controller 18A. Generally speaking, any measurement of a quantum-mechanical state is defined by the operator “O” corresponding to the observable to be measured; the result “R” of the measurement is guaranteed to be one of the allowed eigenvalues of “O”. In the quantum computer 10, “R” is statistically related to the qubit-register state prior to the measurement but is not uniquely determined by the qubit-register state.

Pursuant to appropriate input from the controller 18A, the quantum interface 32 may be configured to implement one or more quantum-logic gates to operate on the quantum state held in the quantum circuit 12, for example, in a qubit register in the quantum circuit 12. Whereas the function of each type of logic gate of a classical computer system is described according to a corresponding truth table, the function of each type of quantum gate is described by a corresponding operator matrix. The operator matrix operates on (i.e., multiplies) the complex vector representing the qubit register state and effects a specified rotation of that vector in Hilbert space.

For example, the Hadamard gate HAD is defined by

$$HAD = \frac{1}{√ 2} [ \begin{matrix}1 & 1 \\ 1 & - 1\end{matrix} ] . \qquad ( A )$$

The HAD gate acts on a single qubit; it maps the basis state |0> to (|0>)/\sqrt{2}, and maps to |1> to (|0>−|1>)\sqrt{2}. Accordingly, the HAD gate creates a superposition of states that, when measured, have equal probability of revealing |0> or |1>.

The phase gate S is defined by

$$S = [ \begin{matrix}1 & 0 \\ 0 & {e}^{i π / 2}\end{matrix} ] . \qquad ( B )$$

The S gate leaves the basis state |0> unchanged but maps |1> to ein 2|1>. Accordingly, the probability of measuring either |0> or |1> is unchanged by this gate, but the phase of the quantum state of the qubit is shifted. This is equivalent to rotating w by 90 degrees along a circle of latitude on the Bloch sphere of FIG. 2.

Some quantum gates operate on two or more qubits. The SWAP gate, for example, acts on two distinct qubits and swaps their values. This gate is defined by

$$SWAP = [ \begin{matrix}1000 \\ 0010 \\ 0100 \\ 0001\end{matrix} ] . \qquad ( C )$$

The foregoing list of quantum gates and associated operator matrices is non-exhaustive, but is provided for ease of illustration. Other quantum gates include Pauli-X, -Y, and -Z gates, the \sqrt{NOT} gate, additional phase-shift gates, the \sqrt{SWAP} gate, controlled cX, cY, and cZ gates, and the Toffoli, Fredkin, Ising, and Deutsch gates, as non-limiting examples.

Continuing in FIG. 1, suitably configured signals from modulators 34 of the quantum interface 32 can interact physically with one or more qubits 14 of the quantum circuit 12, for example, a qubit register in the quantum circuit 12, so as to assert any desired quantum-gate operation. As noted above, the desired quantum-gate operations are specifically defined rotations of a complex vector representing the qubit register state. In order to effect a desired rotation “O”, one or more modulators of quantum interface 32 can apply a predetermined signal level Sᵢ for a predetermined duration Tᵢ. In some examples, plural signal levels can be applied for plural sequenced or otherwise associated durations, as depicted in FIG. 3, to assert a quantum-gate operation on one or more qubits of the quantum circuit 12, for example, in a qubit register of the quantum circuit 12. In general, each signal level Sᵢ and each duration Tᵢ is a control parameter adjustable by appropriate programming of controller 18A.

The term ‘oracle’ is used herein to describe a predetermined sequence of elementary quantum-gate and/or measurement operations executable by quantum computer 10. An oracle can be used to transform the quantum state of qubits 14 in the quantum circuit 12, for example, qubits in a qubit register, to effect a classical or non-elementary quantum-gate operation or to apply a density operator, for example. In some examples, an oracle may be used to enact a predefined ‘black-box’ operation ƒ(x), which may be incorporated in a complex sequence of operations. To ensure adjoint operation, an oracle mapping n input qubits |x> to m output or ancilla qubits |y>ƒ(x) may be defined as a quantum gate O(|x>⊗|y>) operating on the n+m qubits. In this case, O can be configured to pass the n input qubits unchanged but combine the result of the operation f(x) with the ancillary qubits via an XOR operation, such that O(|>⊗t>)=x>⊗|y+f(x)>. As described further below, a state-preparation oracle is an oracle configured to generate a quantum state of specified qubit length.

In one or more embodiments, implicit in the description herein is that each qubit 14 of qubit registers can be interrogated via quantum interface 32 so as to reveal with confidence the standard basis vector |0> or |1> that characterizes the quantum state of that qubit. In some implementations, however, measurement of the quantum state of a physical qubit could be subject to error. Accordingly, any physical qubit 14 can be implemented as a logical qubit, which includes a grouping of physical qubits measured according to an error-correcting oracle that reveals the quantum state of the logical qubit with confidence.

As discussed herein, the quantum computer 10 can be implemented using any quantum computing technology. For example, a trapped-ion quantum computer is one example approach for a large-scale quantum computer. Ions, or charged atomic particles, can be confined and suspended in free space using electromagnetic fields. Qubits are stored in stable electronic states of each ion, and quantum information can be transferred through the collective quantized motion of the ions in a shared trap (interacting through the Coulomb force). Lasers are applied to induce coupling between the qubit states (for single qubit operations) or coupling between the internal qubit states and the external motional states (for entanglement between qubits). The fundamental operations of a quantum computer have been demonstrated with the currently highest accuracy in trapped-ion systems.

Another example quantum computer is a neutral atom quantum computer which is a modality of quantum computers built out of Rydberg atoms; this modality has many commonalities with trapped-ion quantum computers. The concept has been used to demonstrate a 48 logical qubit processor. To perform computation, the atoms are first trapped in a magneto-optical trap. Qubits are then encoded in the energy levels of the atoms. Initialization and operation of the computer is performed via the application of lasers on the qubits. For example, the laser can accomplish arbitrary single qubit gates and a CZ gate for universal quantum computation. The CZ gate is carried out by leveraging the Rydberg blockade which leads to strong interactions when the qubits are physically close to each other. To perform a CZ gate, a Rydberg pulse π is applied to the control qubit, a 2π on the target qubit, and then a π on the control. Measurement is enforced at the end of the computation with a camera that generates an image of the outcome by measuring the fluorescence of the atoms.

Further example quantum computers include linear optical quantum computing or linear optics quantum computation (LOQC), also referred to as photonic quantum computing (PQC). LOQC is a paradigm of quantum computation that allows (under certain conditions) universal quantum computation. LOQC uses photons as information carriers, mainly using linear optical elements or optical instruments (including reciprocal mirrors and waveplates) to process quantum information, and uses photon detectors and quantum memories to detect and store quantum information.

Another example is a topological quantum computer, in which the quantum state held in each qubit is a state of two or more braidable quasiparticles, or “anyons”, observed within a non-Abelian topological phase of matter. The world lines of different anyons are quantum mechanically forbidden from intersecting or merging. This feature forces their paths to form stable braids that pass around each other in space-time. Relative to trapped particles used in other types of quantum computers, any on braids are more resistant to quantum decoherence, which is a source of error in quantum computation. However, the realization of a topological quantum computer has the ability to engineer a suitable topological phase and to manipulate the anyons therein.

For explanation purposes and not limitation, FIG. 4 illustrates an example layout of a square lattice of tetrons used to implement a honeycomb and 4.8.8 Floquet codes. In FIG. 4, topological superconducting wires 402 have a Majorana zero mode (MZM) at both ends. Qubit islands 404 correspond to two parallel topological superconducting wires 402 joined by a trivial superconducting backbone, with MZMs 430 labeled according to the box in the upper left. MZMs 430 are illustrated for a single tetron 410 but applies to all of the tetrons 410. Rows of tetrons 410 are separated by coherent links 412, which are floating topological wires. Neighboring qubit islands 404 are connected by semiconducting segments 420, with two semiconducting columns of semiconducting segments 420 separating each column of qubit islands 404. There are also rows of semiconductor regions connected the semiconductor segments 420 to coherent links 412 and superconducting wire 402. The coherent links 412 do not have the qubit islands 404. The superconducting wires 402 connect to qubit islands 404, which are the physical qubits 14 in the quantum circuit 12. Since the physical qubits 14 are arranged in an array, the qubit islands 404 are in columns. A semiconductor segment 406 can be referred to as length-1 semiconductor quantum dot with gate defined. A semiconductor segment 408 can be referred to as length-2 semiconductor quantum dot with gate defined.

Each tetron 410 in FIG. 4 includes a physical qubit, where the qubit islands 404 are the physical qubits 14. The tetron 410, which encompasses a qubit island 404, can be referred to as a physical qubit. In the example square lattice as at least a portion of the quantum circuit 12, there is an array of 6*4=24 tetrons displayed, each representing a physical qubit. As seen in FIG. 4, the MZM 430 appears at the end of each topological superconducting wire 402. A quartet of MZMs 430 forms a logical qubit, where each tetron 410 has two topological superconducting wires 402, and each wire has two MZMs 430. Altogether each tetron 410 has 4 MZMs which includes one physical qubit, for example, physical quit 14.

As noted herein, the instructions 24A cause measurements on the quantum circuit 12 using the modulators 34 and demodulators 36. A measurement of one or more physical qubits 14 is the result of sending a signal via the modulator 34 and receiving a signal back via the demodulator 36. The received signal, also referred to as the measurements, has the quantum information about the logical qubit that is formed of two or more physical qubits 14. Based on a signal sent and the received signal from the quantum circuit 12, a logical qubit is formed of two or more physical qubits 14 as understood by one of ordinary skill in the art. The various signals sent and corresponding signals received back can be performed using any desired encoding scheme or code, as understood by one of ordinary skill in the art.

Any code can be implemented in the instructions 24A in the quantum computer 10. In one or more embodiments, any quantum code such as the Calderbank-Shor-Steane (CSS) code, the Hastings-Haah code, etc., can be implemented as computer-executable instructions in the classical computer 100 and sent to the quantum computer 10 for execution. As understood by one of ordinary skill in the art, the quantum code denotes a technique of operating an array of qubits 14 in the quantum circuit 12. Moreover, the quantum code is a sequence of qubit measurements on the quantum circuit 12 of the quantum computer 10, and the classical computer 100 eventually stores those measurement outcomes. That sequence of qubit measurements is programmed into the classical computer 100, which then sends signals to the quantum computer 10, indicating which operations to perform on the quantum circuit 12.

There are several quantum computing architectures based on using Calderbank-Shor-Steane (CSS) quantum codes to implement logical Clifford operations to high accuracy, and then using state injection to inject “magic states” into these codes to perform non-Clifford operations. In any state injection scheme, the scheme has to minimize the error created by encoding the state (which is initially stored in one or a small number of qubits) into the code. Using the surface code, a state-of-the-art scheme was described by Ying Li, in A magic state's fidelity can be superior to the operation that created it, 2015, New J. Phys. 17 023037, which is herein incorporated by reference. This scheme by Li can offer reduced error compared to other scheme based on unitary encoding circuits, with its error rate potentially smaller than that of a single two qubit gate.

In accordance with one or more embodiments, the present disclosure provides a generalization of Li's scheme, so as to be valid for an arbitrary stabilizer code C with an arbitrary number of logical qubits. According to one or more embodiments, let k denote the number of logical qubits.

The present disclosure first considers the case of a CSS code, and then describes the case of a non-CSS code. Finally, the present disclosure explains how these schemes for the CSS code and the non-CSS can be turned into decoding schemes. Although headings are utilized below, it should be appreciated that the headings are not to for limitation. Rather, the headings are provided to assist the reader.

### I. CSS Code

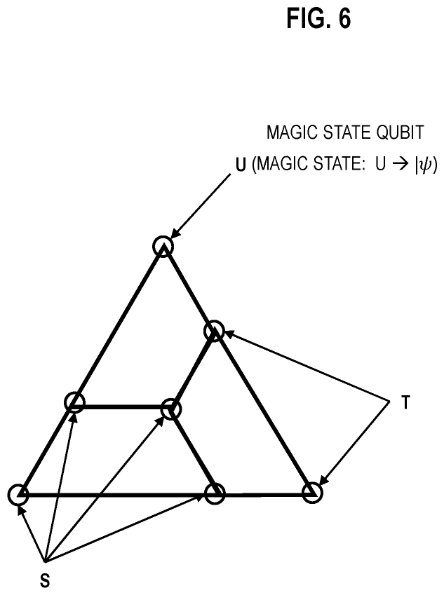

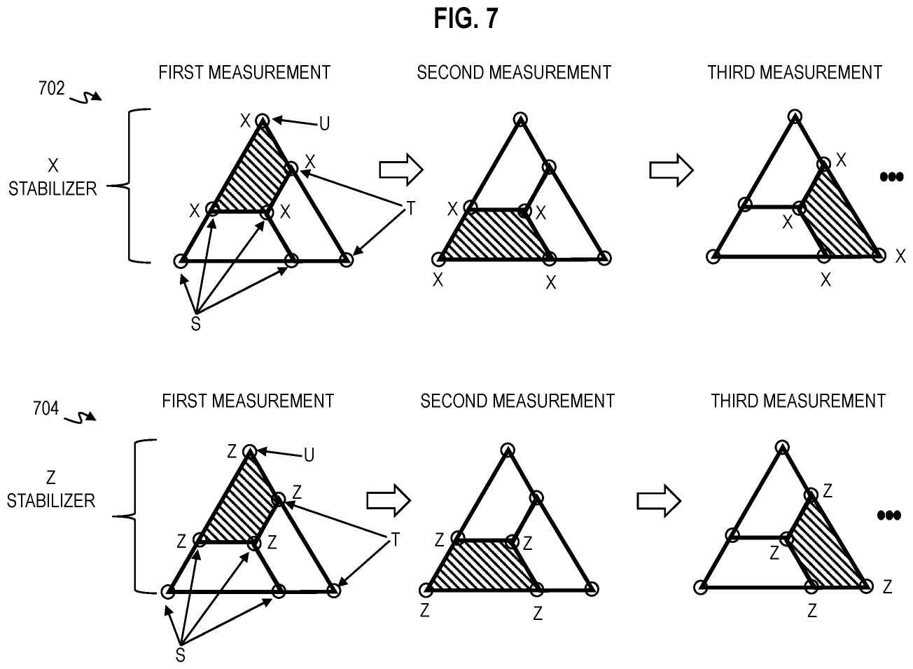

An example CSS code scheme is as follows for using state injection to inject “magic states” into the code. The software 111 of the classical computer 100 causes the quantum circuit 12 to perform quantum operations on the qubits 14 in order to receive measurements or measurement outcomes from the qubits 14. The classical computer 100 and/or the controller 18A receives the measurements or measurement outcomes, checks for errors, performs error correction, and/or causes further quantum operations to be performed on the qubits 14 of the quantum circuit 12 according to the states of the qubits 14 including any errors that are corrected and/or errors that could not be corrected. The quantum circuit 12 is controlled by the classical computer 100 and/or the controller 18A to perform the following procedure.
A1. Pick three sets of physical qubits, S, T, U. Each physical qubit of the code is in exactly one of the sets. FIG. 6 depicts a schematic of the protocol for encoding a magic state in a quantum error correction code, such as the Stearne code. In FIG. 6, the circles represent physical qubits. FIG. 6 illustrates a set S as one set formed by physical qubits, a set T as one set formed by physical qubits, and a set U as another set formed by a physical qubit.
B1. Initialize all physical qubits in the set S to |0). For example, the physical qubits within the set S are initialized to |0) in FIG. 6.
C1. Initialize all physical qubits in set T to |+). For example, the physical qubits within the set T are initialized to |+) in FIG. 6.
D1. Initialize the physical qubits in U into arbitrary magic states. The set U has cardinality k, and the physical qubits in U are initialized to arbitrary magic states (or even to an entangled state), which are eventually injected into the logical qubits of the code. In FIG. 6, the set U is depicted with one physical qubit having a magic state for illustrative purposes. In one or more embodiments, the set U can have two or more physical qubits in which each physical qubit has its own magic state, such that the magic states of the physical qubits are injected into the logical qubits of the code.
E1. After the initialization for sets S, T, and U, measure stabilizers of the code for some number of rounds (example stabilizer measurements are depicted in FIG. 7), until the error in the stabilizers (e.g., X stabilizer and Z stabilizer) is reduced to the desired value. The desired value is selected in advance. An example of the desired value may be such that the probability of an undetected logical fault is reduced to smaller than 10-12. The number of rounds required depends on the code; for the surface code, the number of rounds may be proportional to the code distance, but for single shot codes one may need only O(1) rounds.

The following properties are to hold true for these three sets (S, T, U) of physical qubits:
1A. There is no Z-type logical operator supported on S.
2A. There is no X-type logical operator supported on T.
3A. Every Z-type logical operator can be written as a product of stabilizers times an operator supported on S∪U.
4A. Every X-type logical operator can be written as a product of stabilizers times an operator supported on T∪U.
5A. U has cardinality k.

An example of a Z-type logical operator is a Pauli Z operator. An example of a X-type logical operator is a Pauli X operator. As understood by one of ordinary skill in the art, a product of Pauli operators is supported on a set if it is a product of Pauli operators on that set. As understood by one of ordinary skill in the art, a product of Pauli operators has support on a set if it is the product of some nontrivial Pauli operators on that set with operators on other sets.

Given these properties 1A, 2A, 3A, 4A, and 5A, there is a basis of Z-type logical operators supported on S∪U and a basis of X-type logical operators supported on T∪U. By performing linear algebra on these operators, one can construct a basis where for each physical qubit q there is one Z-type logical operator supported on S∪{q} and one X-type logical operator supported on T∪{q}. The present disclosure calls these operators \tilde{Z}_{q} and \tilde{X}_{q} for qubits q in the set U. Then, this procedure injects the (possibly entangled) magic state on U into the code subspace, mapping Z_{q}→\tilde{Z}_{q} and X_{q}→\tilde{X}_{q}, (where Z_{q} represents a Pauli Z operator on qubit q and where X_{q} represents a Pauli X operator on qubit q).

Properties 3A and 4A follow from properties 1A and 2A by using the cleaning lemma (described by S. Bravyi and B. Terhal, in A no-go theorem for a two- dimensional self-correcting quantum memory based on stabilizer codes, New Journal of Physics 11, 043029 (2009)), but the present disclosure states them explicitly below.

To show that such sets S, T, U exist, the present disclosure works inductively. The present disclosure starts with U containing all physical qubits, which means that properties 1A and 2A are trivially satisfied but property 5A is not satisfied. The present disclosure then removes physical qubits one at a time from U, moving them to either S or T, so that properties 1A and 2A remain true, and this process of removing physical qubits is repeated until U has cardinality k.

To show that it is possible to remove a physical qubit from U if the cardinality of U is greater than k, the present disclosure considers some given S, T, U obeying properties 1A, 2A, 3A, and 4A and considers possible logical Z-type operators supported on S∪U. To understand these, the present disclosure can use linear algebra on the stabilizer group. When considering the group of X-type stabilizers, one can (by Gaussian elimination) find a basis for this group with the property that some of the elements, call them e₁, . . . , eₖ, are supported just on T∪U, and such that the remaining elements, call them ƒ₁ . . . ƒₗ, that have some support on S have the property that their restriction to S is non-degenerate, meaning that any nontrivial linear combination of ƒ₁ . . . ƒₗ has support on S. Now, the present disclosure considers some possible Z-type logical operator on S∪U. The possible Z-type logical operator on S∪U can be written as some operator O_{S} on S times some operator O_{U} on U. The present disclosure considers a given O_{U} and asks whether O_{U} can be made to commute with all X stabilizers by multiplying O_{U} by an appropriate O_{S}. The present disclosure claims that it suffices to commute with elements e₁ . . . eₖ of the X stabilizer group; the present disclosure claims O_{S} O_{U} can be chosen to commute with ƒ₁ . . . ƒₗ by picking O_{S} correctly. So, to put the needed property in words: “given an O_{U}, there is an O_{S} such that the product O_{S}O_{U} commutes with all X-stabilizers if O_{U} commutes with all elements of the X-type stabilizer group which are supported on T∪U″. To check if O_{U} commutes with all such elements of the X-type stabilizer group, the present disclosure can take elements of the X-type stabilizer group supported on T∪U and take their restriction to U (i.e., just consider they generate if one ignores that they are on U) and that gives some group of X-type operators on U. In the coding theory language, that group is called the group given by taking the X-type stabilizer group, shortening it to T∪U, and then puncturing it to U. That group is called G_{X}. As understood by one of ordinary skill in the art, given a code which is a set of bits strings on bits b_1, . . . , b_n, a code which is shortened on bit b_1 is a set of bit strings b_2, . . . , b_n such that 0,b_2, . . . , b_n is in the original code, while a punctured code is a set of bit strings b_2, . . . , b_n such that b, b_2, . . . , b_n is in the original code for some b.

Similarly, by interchanging X and Z and interchanging S and T, any logical X-type operator supported on T∪U can be written as a product O_{T}O_{U}, where O_{U} must commute with some similarly defined group G_{Z}. The groups G_{X} and G_{Z} commute with each other. Accordingly, G_{X} and G_{Z} may be regarded as some stabilizer group for some quantum code on U.

Therefore, G_{X} and G_{Z} define some CSS stabilizer code on U, with, indeed, also k logical qubits. So, if U has more than k logical qubits, there must be some physical qubit q in U which does not have a Z-type logical operator supported on it (i.e., that physical qubit q) or does not have an X-type logical operator supported on that, and if every physical qubit q in U had both a Z-type and an X-type logical operator supported on it, then G_{X} and G_{Z} would both be the trivial group containing only the identity element, and the number of logical qubits on U would be the cardinality of U. Then, the present disclosure moves that qubit q to S or T, respectively.

As a remark, it is noted that a further generalization of this procedure can also be used to inject an encoded state C. Suppose the present disclosure terminates the above inductive proof when U has some number m>k qubits. Then, G_{X} and G_{Z} define some CSS code on U with some nontrivial stabilizers in which that CSS code on U is called code C_{U}. If a state of C_{U} is prepared, then the present disclosure can inject the state of C_{U} into C in this way.

The above procedure A1, B1, C1, D1, and E1 can be performed for a general/arbitrary error correction code (e.g., arbitrary stabilizer code C) according to one or more embodiments. This is different from the scheme in Li because Li is only for a specific code and is limited to a specific choice of sets for that code.

The stabilizer measurements act on all sets S, T, and U. Although only three stabilizer measurements are illustrated in FIG. 7, there are some stabilizers contained entirely in S, some stabilizers contained entirely in T, some stabilizers container entirely in U, etc. Some stabilizers act on both S and T, some stabilizers act on S and U, some stabilizers act on T and U, some stabilizers act on S, T, and U simultaneously, etc. This action of measuring the stabilizers acts on all three sets S, T, and U simultaneously, which causes the injection of the magic state(s) of set U into the code. This means that the magic state(s) of set U are injected into the logical qubits of the code.

FIG. 7 depicts first stabilizer measurements, second stabilizer measurements, and third stabilizer measurements for X stabilizers and Z stabilizers in views 702 and 704, respectively. The first stabilizer measurement in view 702 is an X stabilizer measurement that acts on all three sets S, T, and U simultaneously, thereby injecting the magic state(s) of set U into the logical qubits of the code. Similarly, the first measurement stabilizer in view 704 is a Z stabilizer measurement that acts on all three sets S, T, and U simultaneously, thereby injecting the magic state(s) of set U into the logical qubits of the code.

The second stabilizer measurement in view 702 is an X stabilizer measurement that acts on the set S. Similarly, the second measurement stabilizer in view 704 is a Z stabilizer measurement that acts on the set S.

The third stabilizer measurement in view 702 is an X stabilizer measurement that acts on the sets S and T. Similarly, the second measurement stabilizer in view 704 is a Z stabilizer measurement that acts the sets S and T.

To perform the stabilizer measurements for the X stabilizer and the Z stabilizer, ancillary qubits can be utilized to make the X and Z measurements such as by performing Pauli X measurements and Pauli Z measurements, respectively. In one or more embodiments, CNOT gates are performed between the physical qubits and the ancillary qubit, and then the X measurement is taken for the X stabilizer. In one or more embodiments, CNOT gates are performed between the physical qubits and the ancillary qubit, and then the Z measurement is taken for the Z stabilizer. The X measurements for the X stabilizer and the Z measurements for the Z stabilizer are checked for any errors. The outcomes of the X measurements are expected to be +1, and the outcomes for the Z measurements are expected to be +1. An error occurs if any of the outcomes for the X measurements or the Z measurements is not +1. If an error is found, all the states are discarded for the sets S, T, and U, and the procedure of operations A1, B1, C1, D1, and E1 is repeated again. Alternatively, an error correction protocol may be applied, correcting errors up to some predefined number. This will increase the throughput of the injection procedure at the cost of additional errors in the created state. The number of errors that is corrected may be chosen to keep the error rate small while keeping an acceptable throughput.

### II. Non-CSS Code

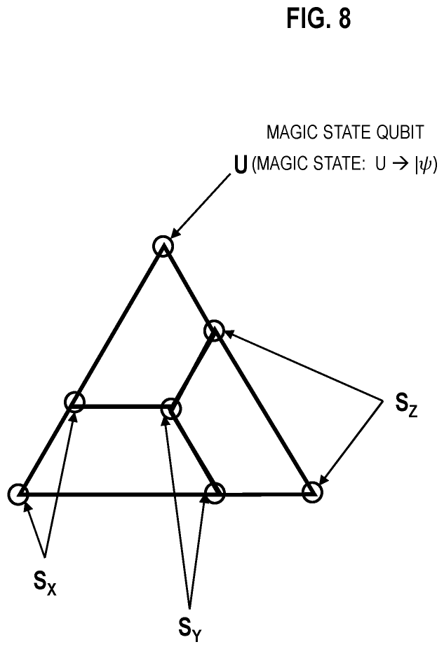

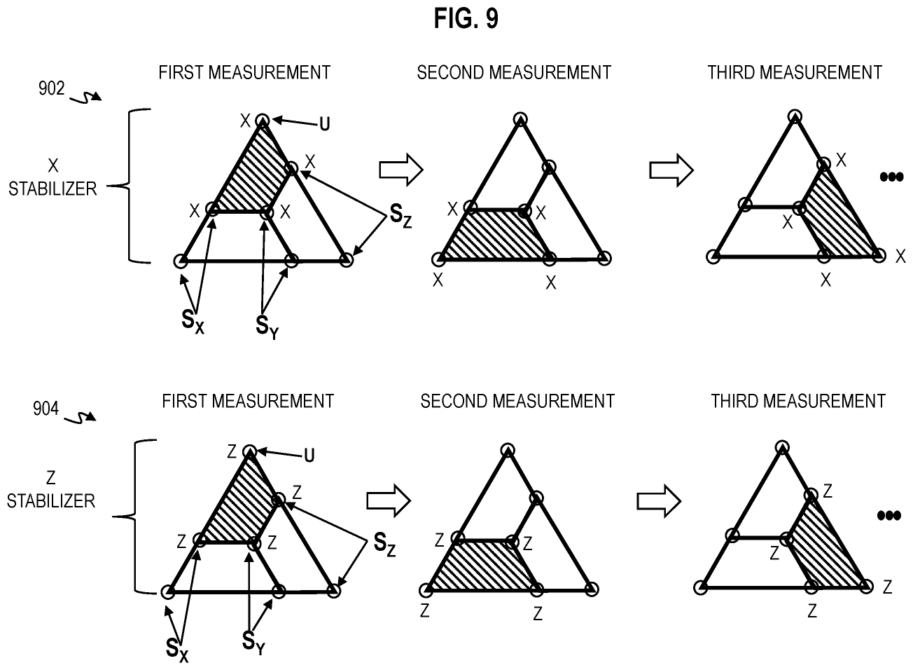

According to one or more embodiments, it is now assumed that Cis an arbitrary, non-CSS stabilizer code. As noted herein, the software 111 of the classical computer 100 causes the quantum circuit 12 to perform quantum operations on the qubits 14 in order to receive measurements or measurement outcomes from the qubits 14. The classical computer 100 and/or the controller 18A receives the measurements or measurement outcomes, checks for errors, performs error correction, and/or causes further quantum operations to be performed on the qubits 14 of the quantum circuit 12 according to the states of the qubits 14 including any errors that are corrected and/or errors that could not be corrected. The quantum circuit 12 is controlled by the classical computer 100 and/or the controller 18A to perform the following procedure for a non-CSS stabilizer code.
A2. Construct four sets of physical qubits, S_{X}, S_{Y}, S_{Z}, U, such that each qubit is in exactly one of these sets.
B2. Initialize physical qubits in S_{X} to X=+1, physical qubits in S_{Y} to Y=+1, and physical qubits in S_{Z} to Z=+1. The present disclosure can write a set S=S_{X} ∪S_{Y}∪S_{Z}. The present disclosure can say that an operator supported on S is (defined as) a “standard type” if the supported operator is a product of Pauli X over some subset of S_{X} times Pauli Y over some subset of S_{Y} times Pauli Z over some subset of S_{Z}. These subsets may be empty.
C2. Initialize the physical qubits in U into arbitrary magic states. The set U has cardinality k, where k is the number of elements in the set U; the physical qubits in U are initialized to arbitrary magic states (or even to an entangled state), which are eventually injected into the logical qubits of the code. In FIG. 8 for a non-CSS scheme, the set U is depicted with one physical qubit having a magic state for illustrative purposes. In one or more embodiments, the set U can have two or more physical qubits in which each physical qubit has its own magic state, such that the magic states of the physical qubits are injected into the logical qubits of the code.
D2. After the initialization for sets S_{X}, S_{Y}, S_{Z}, and U, measure stabilizers of the code for some number of rounds (example stabilizer measurements are depicted in FIG. 9), until the error in the stabilizers (e.g., X stabilizer and Z stabilizer) is reduced to the desired value. The desired value is selected in advance. The number of rounds required depends on the code; for the surface code, the number of rounds may be proportional to the code distance, but for single shot codes one may need only O(1) rounds.

The following properties are to hold true for these four sets (S_{X}, S_{Y}, S_{Z}, U) of physical qubits:
1B. There is no logical operator supported on S which is a standard type.
2B. Every logical operator can be written as some standard type operator supported on S times some operator supported on U.
3B. The set U has cardinality k.

Having done this by linear algebra, the present disclosure can find a basis of logical operators where for each physical qubit in q, there are two logical operators, \tilde{X}_{q} and \tilde{Z}_{q}, each of which is a product of either Pauli X or Z on q, respectively, times some operator supported on S of a standard type. Then, this procedure injects the (desired magic) state on S into the code space of C, mapping X_{q} and Z_{q} to \tilde{X}_{q} and \tilde{Z}q, respectively.

To construct these sets (S_{X}, S_{Y}, S_{Z}, U), the present disclosure again proceeds inductively, starting with U containing all physical qubits. The present disclosure removes one at a time from U, adding them to either S_{X}, S_{Y}, or S_{Z}, keeping property 1B satisfied, until U has cardinality k; after some number of steps, having choosen S_{X}, S_{Y}, and S_{Z}, this defines some stabilizer code C_{U} on U. This stabilizer code C_{U} is defined to have a stabilizer group consisting of all operators supported on U, such that that operator multiplied by an operator of standard type supported on S is in the stabilizer group of C. Assuming property 1B continues to hold true up to that point, the code C_{U} has k logical qubits. If some qubit q cannot be added to S_{X}, then that means that Pauli X on that qubit times an operator of standard type supported on S is a logical operator of C, which means that Pauli X on q is a logical operator of C_{U}. Similarly, if q cannot be added to S_{Y} or S_{Z}, with X replaced by Y or Z, respectively, there must be some qubit q in U which can be added to some set S_{X}, S_{Y}, or S_{Z} unless the cardinality of U is equal to the number of logical qubits of C_{U}, i.e., unless U has cardinality k.

It can be seen that property 2B follows from property 1B by a generalization of the cleaning lemma. Indeed, the present disclosure now considers tensoring the code C with k additional ancilla qubits, and starting with a pure stabilizer state which is a code state of C with the logical qubits of C maximally entangled with the ancilla qubits. So, the present disclosure has stabilizers \tilde{Z}ₐZₐ and \tilde{K}ₐXₐ where Xₐ and Zₐ are Pauli operators on ancilla qubit a, and \tilde{Z}ₐ and \tilde{X}ₐ are logical operators of C, anticommuting with each other and commuting with logical \tilde{Z}b and \tilde{X}_{b} for b≠a. It is noted that \tilde{Z}ₐ and \tilde{X}ₐ might not be products of Pauli Z or Pauli X. The present disclosure measures the physical qubits in S in the appropriate bases, X, Y, or Z. This state remains pure, and this does not measure any of the logical operators, so the remaining state on U must be maximally entangled with the ancilla qubits. However, since this does not measure any of the logical operators, this means one can multiply each logical \tilde{Z}ₐ or \tilde{X}ₐ by elements of the stabilizer group of C so that it commutes with the measurements, i.e., so that it is an operator on S of standard type times an operator on U.

The stabilizer measurements act on all sets S_{X}, S_{Y}, S_{Z}, and U. Although only three stabilizer measurements are illustrated in FIG. 9, there are some stabilizers contained entirely in S_{X}, some stabilizers contained entirely in S_{Y}, some stabilizers contained entirely in S_{Z}, some stabilizers container entirely in U, etc. Some stabilizers act on both S_{X} and S_{Y}, some stabilizers act on S_{Y} and S_{Z}, some stabilizers act on S_{X}, S_{Y}, S_{Z}, and U simultaneously, etc. This action of measuring the stabilizers acts on all four sets S_{X}, S_{Y}, S_{Z}, and U simultaneously, which causes the injection of the magic state(s) of set U into the logical qubits of the code.

FIG. 9 depicts first stabilizer measurements, second stabilizer measurements, and third stabilizer measurements for X stabilizers and Z stabilizers in views 902 and 904, respectively for a non-CSS scheme. The first stabilizer measurement in view 902 is an X stabilizer measurement that acts on all four sets S_{X}, S_{Y}, S_{Z}, and U simultaneously, thereby injecting the magic state(s) of set U into the logical qubits of the code. Similarly, the first measurement stabilizer in view 904 is a Z stabilizer measurement that acts on all three sets S_{X}, S_{Y}, S_{Z}, and U simultaneously, thereby injecting the magic state(s) of set U into the logical qubits of the code.

The second stabilizer measurement in view 902 is an X stabilizer measurement that acts on the sets S_{X} and S_{Y}. Similarly, the second measurement stabilizer in view 904 is a Z stabilizer measurement that acts on the sets S_{X} and S_{Y}.

The third stabilizer measurement in view 902 is an X stabilizer measurement that acts on the sets S_{Y} and S_{Z}. Similarly, the second measurement stabilizer in view 904 is a Z stabilizer measurement that acts the sets S_{Y} and S_{Z}.

To perform the stabilizer measurements for the X stabilizer and the Z stabilizer for the four sets S_{X}, S_{Y}, S_{Z}, and U, ancillary qubits can be utilized to make the X and Z measurements such as by performing Pauli X measurements and Pauli Z measurements, respectively. In one or more embodiments, CNOT gates are performed between the physical qubits and the ancillary qubit, and then the X measurement is taken for the X stabilizer. In one or more embodiments, CNOT gates are performed between the physical qubits and the ancillary qubit, and then the Z measurement is taken for the Z stabilizer. The X measurements for the X stabilizer and the Z measurements for the Z stabilizer are checked for any errors. The outcomes of the X measurements are expected to be +1, and the outcomes for the Z measurements are expected to be +1. An error occurs if any of the outcomes for the X measurements or the Z measurements is not +1. If an error is found, all the states are discarded for the sets S, T, and U, and the procedure of operations A2, B2, C2, and D2 is repeated again. Alternatively, an error correction protocol may be applied, correcting errors up to some predefined number. This will increase the throughput of the injection procedure at the cost of additional errors in the created state. The number of errors that is corrected may be chosen to keep the error rate small while keeping an acceptable throughput.

### III. Decode Scheme

The CSS and non-CSS schemes above inject (or encode) k (logical) qubits into a code. Conversely, these schemes for CSS and non-CSS codes can be used for the inverse operation of decoding and mapping the logical qubits of a code into physical qubits. For example, the decode scheme can take an arbitrary stabilizer code, and measure (physical) qubits in set S_{X} in the X basis, set S_{Y} in the Y basis, and set S_{Z} in the Z basis. Then, U holds the state of the logical qubits, up to a Pauli frame change which can be computed from the measurement outcomes.

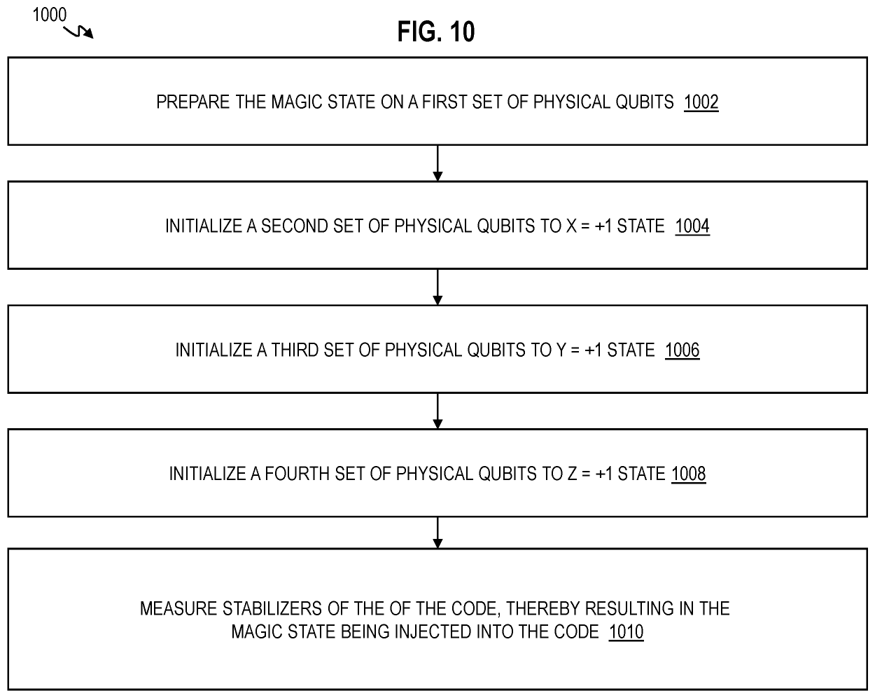

Now turning to FIG. 10, a flowchart of computer-implemented method 1000 for injecting a magic state into logic states of a non-CSS stabilizer quantum code according to one or more embodiments. The software 111 of the classical computer and/or the controller 18A of the quantum computer 10 causes the quantum circuit 12 to perform quantum operations on the physical qubits 14 in order to receive measurements or measurement outcomes from the physical qubits 14.

At block 1002, the quantum circuit 12 is configured to prepare the magic state on a first set (e.g., set U) of physical qubits, initialize a second set (e.g., set S_{X}) of the physical qubits to X=+1 state at block 1004, initialize a third set (e.g., set S_{Y}) of the physical qubits to Y=+1 state at block 1006, initialize a fourth set (e.g., set S_{Z}) of the physical qubits to Z=+1 state at block 1008, and measure stabilizers of the code (e.g., as depicted in FIG. 9), thereby resulting in the magic state being injected into the code at block 1010.

Further, measuring the stabilizers of the code comprises performing Pauli X stabilizer measurements, the Pauli X stabilizer measurements including at least one Pauli X stabilizer measurement concurrently measuring part of the first, second, third, and fourth sets of the physical qubits (e.g., as depicted in view 902 of FIG. 9). Measuring the stabilizers of the code comprises performing Pauli Z stabilizer measurements, the Pauli Z stabilizer measurements including at least one Pauli Z stabilizer measurement concurrently measuring part of the first, second, third, and fourth sets of the physical qubits (e.g., as depicted in view 904 of FIG. 9).

In response to an error being found on the measurements of the stabilizers (by classical computer 100 and/or the controller 18A), the quantum circuit 12 is configured to discard states of the first, second, third, and fourth sets of physical qubits, prepare the magic state on the first set, initialize the second set to the X=+1 state, initialize the third set to the Y=+1 state, and initialize the fourth set to the Z=+1 state. In response to an error being found on the measurements of the stabilizers, error correction is performed (by classical computer 100 and/or the controller 18A).

The first set has a cardinality k, and a set S comprises a union of the second set, the third set, and the fourth set (e.g., the set S=S_{X} ∪S_{Y}∪S_{Z}).

The classical computer 100 and/or the controller 18A is configured to decode logical qubits of the code into the physical qubits based on the first set, the second set, the third set, and the fourth set. The decoding comprises measuring (by the quantum circuit 12) the second set in an X basis, measuring the third set in a Y basis, and measuring the fourth set in a Z basis; the first set holds a state of the logical qubits of the code based on measurement outcomes (from the quantum circuit 12) of the decoding.

Logical qubits of the code have been injected with the magic state, and the quantum circuit 12 is configured to perform a Clifford gate (e.g., CNOT gate) using the logical qubits of the code having the magic state. Logical qubits of the code have been injected with the magic state, and the quantum circuit 12 is configured perform a non-Clifford gate (e.g., a T gate) using the logical qubits of the code having the magic state.

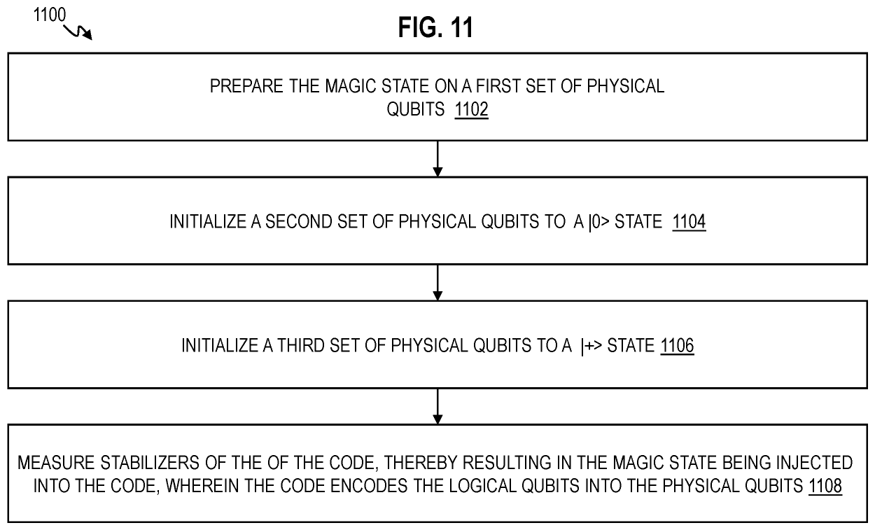

FIG. 11 depicts a flowchart of computer-implemented method 1100 for injecting a magic state into logic states of a CSS stabilizer quantum code according to one or more embodiments. As noted herein, the software 111 of the classical computer and/or the controller 18A of the quantum computer 10 causes the quantum circuit 12 to perform quantum operations on the physical qubits 14 in order to receive measurements or measurement outcomes from the physical qubits 14.

At block 1102, the quantum circuit 12 is configured to prepare a magic state on a first set of physical qubits, initialize a second set of the physical qubits to a [0> state at block 1104, initialize a third set of the physical qubits to a |+> state at block 1106, and measure stabilizers of the code, thereby resulting in the magic state being injected into the code, where the code encodes the logical qubits onto the physical qubits at block 1108.

In one or more embodiments, the quantum error correction code is a general code. In one or more embodiments, the quantum error correction code excludes a surface code. In one or more embodiments, the novel technique allows the injection of (the magic state into) k>1 logical qubits (k may be arbitrary, depending on the code). The sets S, T, and U are chosen differently in one or more embodiments of the present disclosure than any supposed sets in the state-of-the-art. One or more embodiments allow non-CSS codes while Li is only for one specific CSS code.

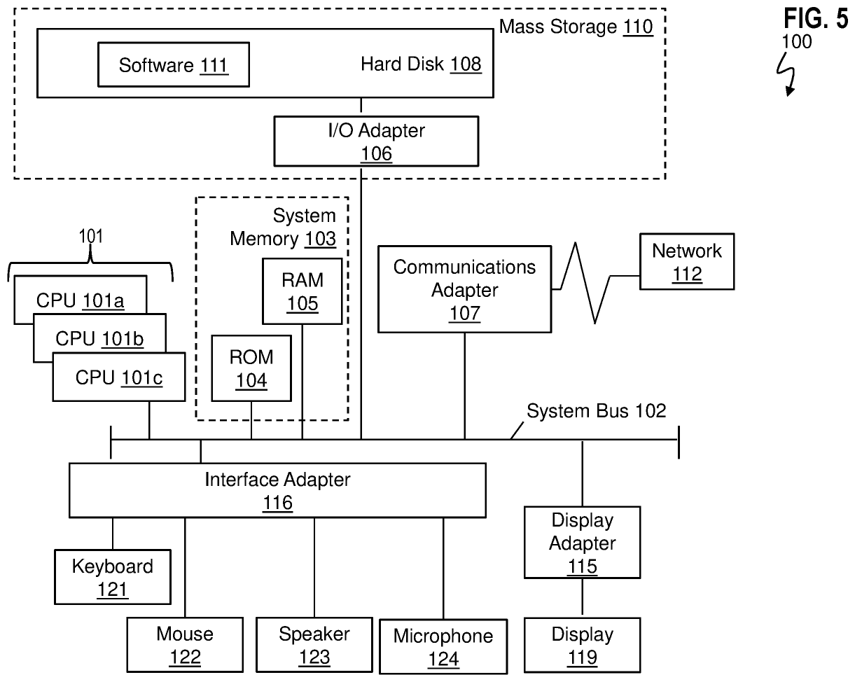

Turning now to FIG. 5, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5 the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 5.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 5, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 5 is not intended to indicate that the computer system 100 is to include all of the components shown in FIG. 5. Rather, the computer system 100 can include any appropriate fewer or additional components not illustrated in FIG. 5 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the invention are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product at any possible technical detail level of integration. The computer program product may include a computer readable storage medium (or media) having computer readable program instructions thereon for causing a processor to carry out aspects of the present invention.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method for injecting a magic state into a code, the method comprising:
preparing the magic state on a first set of physical qubits;
initializing a second set of the physical qubits to X=+1 state;
initializing a third set of the physical qubits to Y=+1 state;
initializing a fourth set of the physical qubits to Z=+1 state; and
measuring stabilizers of the code, thereby resulting in the magic state being injected into the code.

2. The method of claim 1, wherein measuring the stabilizers of the code comprises performing Pauli X stabilizer measurements, the Pauli X stabilizer measurements including at least one Pauli X stabilizer measurement concurrently measuring part of the first, second, third, and fourth sets of the physical qubits.

3. The method of claim 1, wherein measuring the stabilizers of the code comprises performing Pauli Z stabilizer measurements, the Pauli Z stabilizer measurements including at least one Pauli Z stabilizer measurement concurrently measuring part of the first, second, third, and fourth sets of the physical qubits.

4. The method of claim 1, further comprising, in response to an error being found on measurements of the stabilizers, discarding states of the first, second, third, and fourth sets of the physical qubits;
preparing the magic state on the first set;
initializing the second set to the X=+1 state;
initializing the third set to the Y=+1 state; and
initializing the fourth set to the Z=+1 state.

5. The method of claim 1, wherein in response to an error being found on measurements of the stabilizers, error correction is performed.

6. The method of claim 1, wherein:
the first set has a cardinality k; and
a set S comprises a union of the second set, the third set, and the fourth set.

7. The method of claim 1, further comprising decoding logical qubits of the code into the physical qubits based on the first set, the second set, the third set, and the fourth set.

8. The method of claim 7, wherein:
the decoding comprises measuring the second set in an X basis, measuring the third set in a Y basis, and measuring the fourth set in a Z basis; and
the first set holds a state of the logical qubits of the code based on measurement outcomes of the decoding.

9. The method of claim 1, wherein logical qubits of the code have been injected with the magic state;
further comprising performing a Clifford gate using the logical qubits of the code having the magic state.

10. The method of claim 1, wherein logical qubits of the code have been injected with the magic state;
further comprising performing a non-Clifford gate using the logical qubits of the code having the magic state.

11. A system for injecting a magic state into a code comprising:
a quantum circuit coupled to a computer, the computer causing the quantum circuit to perform operations comprising:
preparing the magic state on a first set of physical qubits;
initializing a second set of the physical qubits to X=+1 state;
initializing a third set of the physical qubits to Y=+1 state;
initializing a fourth set of the physical qubits to Z=+1 state; and
measuring stabilizers of the code, thereby resulting in the magic state being injected into the code.

12. The system of claim 11, wherein measuring the stabilizers of the code comprises performing Pauli X stabilizer measurements, the Pauli X stabilizer measurements including at least one Pauli X stabilizer measurement concurrently measuring part of the first, second, third, and fourth sets of the physical qubits.

13. The system of claim 11, wherein measuring the stabilizers of the code comprises performing Pauli Z stabilizer measurements, the Pauli Z stabilizer measurements including at least one Pauli Z stabilizer measurement concurrently measuring part of the first, second, third, and fourth sets of the physical qubits.

14. The system of claim 11, wherein the computer causes the quantum circuit to perform operations further comprising, in response to an error being found on measurements of the stabilizers, discarding states of the first, second, third, and fourth sets of the physical qubits;
preparing the magic state on the first set;
initializing the second set to the X=+1 state;
initializing the third set to the Y=+1 state; and
initializing the fourth set to the Z=+1 state.

15. The system of claim 11, wherein in response to an error being found on measurements of the stabilizers, error correction is performed.

16. The system of claim 11, wherein:
the first set has a cardinality k; and
a set S comprises a union of the second set, the third set, and the fourth set.

17. The system of claim 11, wherein the computer causes the quantum circuit to perform operations further comprising decoding logical qubits of the code into the physical qubits based on the first set, the second set, the third set, and the fourth set.

18. The system of claim 17, wherein:
the decoding comprises measuring the second set in an X basis, measuring the third set in a Y basis, and measuring the fourth set in a Z basis; and
the first set holds a state of the logical qubits of the code based on measurement outcomes of the decoding.

19. The system of claim 11, wherein:
logical qubits of the code have been injected with the magic state; and
the computer causes the quantum circuit to perform operations further comprising performing a Clifford gate using the logical qubits of the code having the magic state or performing a non-Clifford gate using the logical qubits of the code having the magic state.

20. A method for injecting magic states into a code, the method comprising:
preparing a magic state on a first set of physical qubits;
initializing a second set of the physical qubits to a |0> state;
initializing a third set of the physical qubits to a |+> state; and
measuring stabilizers of the code, thereby resulting in the magic state being injected into the code, wherein the code encodes logical qubits onto the physical qubits.
